(19) United States
(12) Patent Application Publication
(10) Pub. No.: US 2004/0229017 A1
(43) Pub. Date: Nov. 18, 2004

(54) Permanent colored markings on medical devices

(75) Inventor: David Allen Goodrich, Grapevine, TX (US)

Correspondence Address: HAYNES AND BOONE, LLP, 901 MAIN STREET, SUITE 3100, DALLAS, TX, 75202, US

(73) Assignees: Medtronic Midas Rex, Ft. Worth, TX; SDGI Holdings, Inc., Wilmington, DE

(21) Appl. No.: 10/438,078

(22) Filed: May 14, 2003

(51) Int. Cl. B32B 3/00

(52) U.S. Cl. 428/156

(57) ABSTRACT

A method for permanently marking a medical device substrate includes selecting the medical device substrate and forming one or more recesses on the device substrate. Each recess defines a cavity having a recess opening which defines an opening area and one or more walls. A marking material is applied to the one or more recesses and is cured. After curing, the marking material is mechanically and adhesively secured to the substrate.

### FIELD OF THE INVENTION

The present invention relates generally to medical devices, and more particularly, to a system and method for permanently marking medical devices by applying a colored material to a recessed feature.

### BACKGROUND

Often health care providers require medical devices to have distinguishing marks that can supply information about the device's size, ownership, manufacturer, ability to mate with other devices, and other facts that can enhance the utility and safety of the device. To be suitable for use on medical devices, markings must be durable and have the ability to withstand repeated sterilization processes without degradation. Any marking scheme must also be physically unobtrusive. Furthermore, markings must be easily recognizable in an environment where an abundance of blood and tissue may make device identification difficult. A method is needed for creating relatively permanent markings on medical devices that meet the specifications described.

### SUMMARY

An object of the present invention is to provide an improved method and device for applying permanent colored markings for use on a medical device and the like. In one embodiment, the method includes selecting the medical device substrate and forming one or more recesses on the device substrate. Each recess defines a cavity having a recess opening and one or more walls. The recess opening can form a variety of shapes such as letters, numbers, and annular grooves. A marking material, such as an epoxy system, is then applied to the one or more recesses and cured. When cured, the marking material is adhesively bound to and mechanically secured by the substrate, allowing the marking material to withstand degrading conditions.

Mechanically securing the marking material can be accomplished, in one embodiment, by providing each recess with a securing portion. The area defined by the opening can be smaller than the area defined by the securing portion, allowing marking material, once applied and cured, to be mechanically bound by the substrate. In another embodiment, mechanically securing the marking material can be accomplished by shaping the recess opening in the form of an annular groove. Marking material, once applied to the annular groove and cured, forms a continuous ring retained by the substrate.

### BRIEF DESCRIPTION OF THE DRAWINGS

FIG. 1 is a flow chart of the process to create permanent colored markings on medical devices.

FIG. 2a is a perspective view of a planar surface capable of receiving a permanent colored marking according to a first embodiment of the present invention.

FIG. 2b is an overhead view of a planar surface capable of receiving a permanent colored marking according to a first embodiment of the present invention.

FIG. 2c is a cross sectional view of a planar surface capable of receiving a permanent colored marking according to a first embodiment of the present invention.

FIG. 2d is a cross sectional view of a planar surface capable of receiving a permanent colored marking according to a second embodiment of the present invention.

FIG. 2e is a cross sectional view of a planar surface capable of receiving a permanent colored, marking according to a third embodiment of the present invention.

FIG. 2f is a cross sectional view of a planar surface capable of receiving a permanent colored marking according to a fourth embodiment of the present invention.

FIG. 2g is a cross sectional view of a planar surface capable of receiving a permanent colored marking according to a fifth embodiment of the present invention.

FIG. 2h is a cross sectional view of a planar surface capable of receiving a permanent colored marking according to a sixth embodiment of the present invention.

FIG. 3a is a perspective view of a cylindrical surface capable of receiving a permanent colored marking according to a seventh embodiment of the present invention.

FIG. 3b is a cross sectional view of a cylindrical surface capable of receiving a permanent colored marking according to the eighth embodiment of the present invention.

FIG. 4 is a cross sectional of a cylindrical surface capable of receiving a permanent colored marking according to a ninth embodiment of the present invention.

FIG. 5 is a cross sectional view of a cylindrical surface capable of receiving a permanent colored marking according to an tenth embodiment of the present invention.

FIG. 6 illustrates an application of a marking material.

FIG. 7a is a perspective view of the cylindrical surface of FIG. 3a with a permanent colored marking.

FIG. 7b is a cross sectional view of the cylindrical surface of FIG. 3b with a permanent colored marking filling the recess.

FIG. 7c is a cross sectional view of the cylindrical surface of FIG. 3b with a permanent colored marking overfilling the recess.

FIG. 7d is a cross sectional view of the cylindrical surface of FIG. 3b with a permanent colored marking underfilling the recess.

### DETAILED DESCRIPTION

For the purposes of promoting an understanding of the principles of the present inventions, reference will now be made to the embodiments, or examples, illustrated in the drawings and specific language will be used to describe the same. It will nevertheless be understood that no limitation of the scope of the invention is thereby intended. Any alterations and further modifications in the described embodiments, and any further applications of the principles of the inventions as described herein are contemplated as would normally occur to one skilled in the art to which the invention relates.

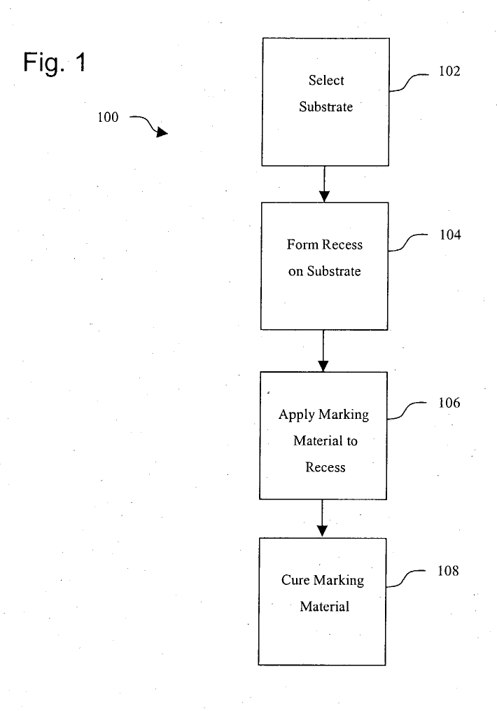

Referring first to FIG. 1, a process 100 can be used to create a permanent colored marking on a device, such as a medical device. Examples of medical devices that can benefit from the process 100 include surgical implants, operating tools, and other devices used in medical, veterinary, or dental practices. The process 100 begins at step 102 by selecting a device substrate. The device substrate can represent the entire device or can be a component part of the device. The device substrate can be comprised of one or more different materials, including metal and non-metal materials. The shape of the device substrate can be any of a variety of geometrical forms, such as planar or cylindrical.

After the substrate is selected, a recess for accepting a colored material can be formed on a surface of the substrate at step 104. The recess can be formed by machining, casting, or any other method known in the art. A substrate can include multiple recesses on the same surface or on multiple surfaces of the substrate.

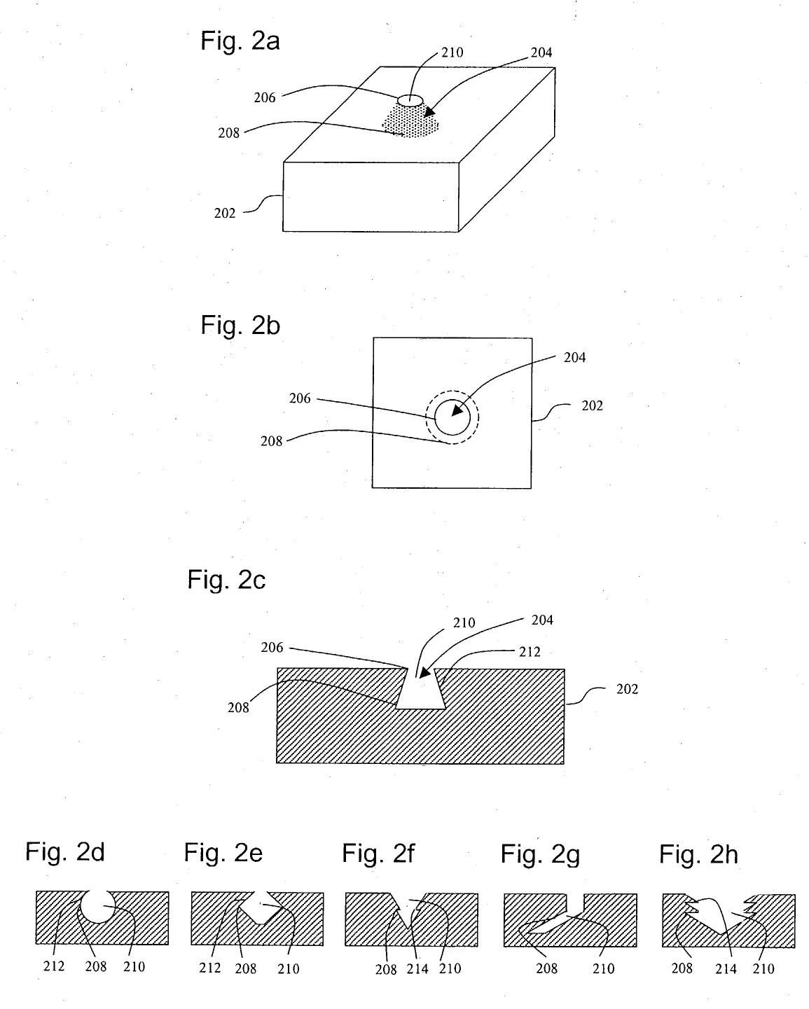

Referring also to FIGS. 2a, 2b, and 2c, in one embodiment, a substrate 202 has a recess 204 which defines a cavity 210 with an opening 206 and a securing portion 208 wherein the opening defines an area smaller than the area defined by the securing portion. This recess 204 allows a viscous material poured into the cavity 210 to become mechanically retained by the substrate 202 after hardening. This mechanical retention occurs because the shape of the cavity restricts the hardened material from passing back through the opening 206. Although FIG. 2a describes a recess with a circular recess opening 206 and a frustum shaped cavity 210, the opening 206 can be formed into any shape including characters, graphics, patterns, or other shapes selected to convey information, provide identification, or create decoration.

As shown in FIG. 2c, the cavity 210 includes one or more walls 212 that can be angled to define the area of the opening 206 to be smaller than the area of the securing portion 208. As shown in FIGS. 2d and 2e, the securing portion 208 can be located at any position along the wall 212 where the area of the opening is smaller than the area of the securing portion. Alternatively, the securing portion 208 can be located at a position where the recess cavity 210 is offset, at least partially, from the opening as in FIG. 2g. In the embodiments shown in FIGS. 2f and 2h, the recess cavity 210 further includes a constricted portion 214 which defines a constricted portion area smaller than the area of the securing portion 208.

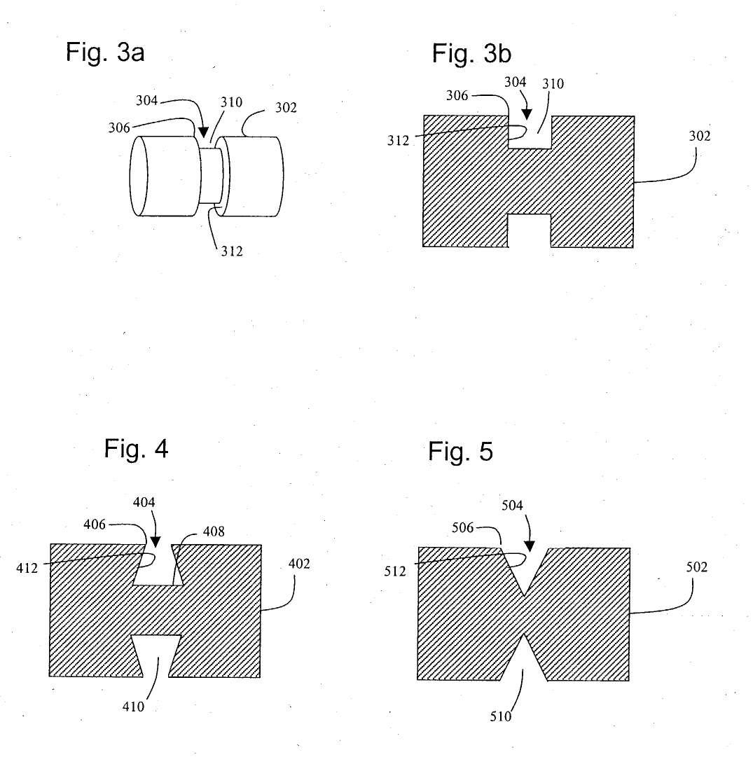

Referring now to FIGS. 3a and 3b, in another embodiment, a substrate 302 has a recess 304 which defines a cavity 310 having an opening 306 and one or more walls 312. In this embodiment, the opening 306 is shaped as an annular groove. The walls 312 of the groove 308 can be parallel as shown in FIG. 3b. The recess 304 allows a viscous material poured into the cavity 310 to become mechanically retained by the substrate 302 after hardening. This mechanical retention occurs because the hardened material forms a continuous ring held in place by the walls 312.

Referring now to FIG. 4, in another embodiment, a substrate 402 has a recess 404 which defines a cavity 410 having an opening 406, a securing portion 408, and one or more walls 412. In this embodiment, the opening 406 is shaped as an annular groove. The walls 412 of the groove 408 can be non-parallel which can cause the area defined by the opening 406 to be smaller than the area defined by the securing portion 408.

Referring now to FIG. 5, in another embodiment, a substrate 502 has a recess 504 which defines a cavity 510 having an opening 506 and one or more walls 512. In this embodiment, the opening 506 is shaped as an annular groove. The walls 512 of the groove 508 can be shaped such that the area defined by the opening 506 is the widest portion of the cavity 510.

Referring again to FIG. 1, after the recess is formed on the substrate, execution proceeds to step 106 where a marking material is applied to the recess. A relatively permanent marking material can be a substance selected to resist fading, peeling, chipping, or other forms of degradation. Furthermore, the marking material can be selected to withstand repeated steam, radiation, and/or chemical sterilization. The marking material can be, for example, a pigmented or pigmentable viscous liquid of an adhesive nature such as an epoxy, urethane, or polyester system. For example, where a two-component epoxy system is chosen to be the marking material, the components can be RBC 501 epoxy resin and REC HC-912 epoxy hardener sold by RBC Industries,.Inc. of Warwick, R.I. The marking material can be available in a wide range of preformulated colors or can be mixed or pigmented to blend unique colors. Where, for example, the marking material is chosen to be a two component epoxy system comprising an epoxy resin and a hardener, the resin and hardener can be mixed at approximately a 2:1 ratio, such as 1.0 g resin to 0.5 g hardener. It is understood that a wide range of resin to hardener ratios can be used depending upon the particular epoxy system used, the type of application, and the desired results. If the resin is not pre-pigmented, pigment can be mixed with the resin and the hardener.

In some embodiments, the application of the marking material may include pre-heating the substrate or heating the substrate while the marking material is being dispensed. In that case, a heat source such as a heated oven or a hot plate can be used to heat the substrate to a desired temperature which can be, for example, 175 F. to 200 F.

A marking material dispensing system can also be utilized. The dispensing system can be for example, a dip and apply method using a probe and a container, a syringe method, or a pneumatically actuated dispensing method. The dispensing system can further include a fixture which can hold the substrate stationary, hold and rotate the substrate relative to the fixture, or hold and otherwise move the substrate relative to the fixture. The prepared marking material can be transferred to the dispensing system. The dispensing system is then used to deposit the marking material into the cavity of the recess.

Referring now to FIG. 6, for the sake of example, a dispensing system 600 will be described for marking the substrate 302 of FIGS. 3a and 3b. In the present example, the dispensing system 600 uses a syringe 602 to dispense a two component epoxy system 604 for marking the substrate 302. The dispensing system 600 includes a fixture 606 for rotating the substrate 302. As described in FIG. 3a and 3b, the selected substrate 302 is cylindrical, and the recess 304 has an opening 306 shaped as an annular groove. In this embodiment, the syringe 602 is filled with the prepared epoxy 604, and the substrate rotates as the epoxy 604 is dispensed from the syringe 602.

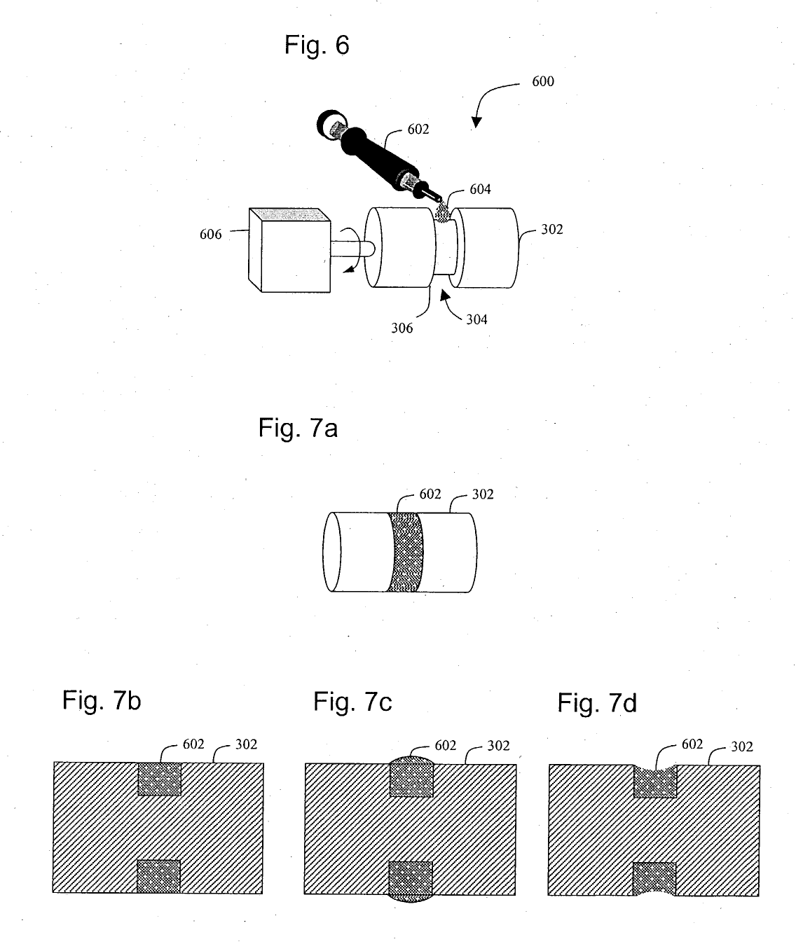

Referring now to FIG. 7a, 7b, 7c, and 7d the epoxy 604 flows into the recess 304 (FIG. 6), and can fill 7b, overfill 7c, or underfill 7d the recess 304 of the substrate 302 depending upon the desired effect. The application process may be repeated until sufficient coverage or thickness is achieved. Where the substrate includes multiple recesses, different marking materials, colors, and dispensing systems can be used to fill each of the recesses. After the fill is complete, the substrate 302 can continue to rotate until the epoxy 604 is sufficiently set up and the substrate 302 can be removed without dislodging the epoxy 604.

Referring again to FIG. 1, at step 108, the applied marking material is cured until a desired consistency is achieved. The marking material can be cured 108 either at room temperature or by exposing the substrate to a curing accelerator such as heat or a chemical curing agent. Where, for example, epoxy is the marking material and heat is chosen as the curing accelerator, the substrate can be placed in a 250 F. oven for approximately 30 to 40 minutes. Alternatively, a 150 F. oven for approximately one hour can be used. Still another alternative is to use an infrared conveyorized oven at a temperature between approximately 260 F. and 270 F. with the substrate in the heated zone of the oven for at least 15 minutes.

The substrates can be mounted on-a curing fixture so that the marking material does not contact an surface other than the substrate during the curing process. Where, for example, the recess opening was shaped as an annular groove, the cured marking material forms a continuous ring which, in addition to being adhesively bound to the substrate, is mechanically retained by the walls of the cavity. Where, for example, the recess is formed such that the recess opening is smaller than the recess securing portion, the cured marking material, in addition to being adhesively bound to the substrate, is mechanically secured by the angled walls of the cavity. Mechanically securing the cured marking material is beneficial because if the adhesive bond is broken, the cured marking material can be retained in the recess. Even if the cured marking material breaks into pieces, only relatively small pieces can be dislodged from the recess.

Advantages of using the permanent colored marking method of the present invention include the ability to mark a medical device with information, identification, or decoration that can withstand repeated sterilization without fading or detaching from the medical device. Also, by overfilling or underfilling the recess, a variety of useful surface textures can be achieved. The marking material may additionally serve to dampen vibrations in the medical device. The method of the present invention further provides a number of fabrication efficiencies such as ability to perform the application in batches or on single units. Also, the method of the present invention does not require a masking procedure to achieve a clean result. Further, the marking can occur during component manufacturing, final assembly, or during a repair procedure. This marking method is flexible enough to allow color selections and recessed pattern designs that are uniquely tailored to a particular manufacturer or customer need.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

I claim:

1. A method for marking a medical device substrate comprising:
selecting the medical device substrate;
forming one or more recesses on the device substrate, wherein each recess defines a cavity having a recess opening which defines an opening area and one or more walls;
applying a marking material to the one or more recesses; and
curing the marking material, wherein the cured marking material is mechanically secured by the substrate, and wherein the cured marking material is adhesively secured to the substrate.

2. The method of claim 1 wherein each recess cavity further includes a recess securing portion which defines a securing portion area.

3. The method of claim 2 wherein the opening area is smaller than the securing portion area.

4. The method of claim 2 wherein each recess cavity further includes a recess constricted portion which defines a constricted portion area, and wherein the constricted portion area is smaller than the securing portion area.

5. The method of claim 1 wherein the recess cavity is offset from the recess opening.

6. The method of claim 1 wherein the recess opening forms an annular groove.

7. The method of claim 1 wherein the recess opening forms a character.

8. The method of claim 1 wherein the recess opening forms a graphic.

9. The method of claim 1 wherein applying the marking material further comprises:
selecting a colored marking material;
selecting a marking material dispensing system;
depositing the marking material in the one or more recesses.

10. The method of claim 9 wherein the selected marking material can withstand repeated sterilizations without substantial degradation.

11. The method of claim 9 wherein the selected marking material is an epoxy system.

12. The method of claim 9 wherein the selected marking material is a urethane system.

13. The method of claim 9 wherein the selected marking material is a polyester system.

14. The method of claim 9 wherein the marking material dispensing system includes a syringe.

15. The method of claim 9 wherein the marking material dispensing system includes a pneumatically actuated dispenser.

16. The method of claim 9 wherein the marking material dispensing system includes a fixture for rotating the substrate.

17. The method of claim 9 wherein depositing the marking material overfills the one or more recesses.

18. The method of claim 9 wherein applying the marking material further comprises:
heating the substrate to a temperature.

19. The method of claim 18 wherein the temperature is approximately between 175 F. and 200 F.

20. The method of claim 1 wherein curing the marking material further comprises:
exposing the applied marking material to a curing accelerator.

21. The method of claim 20 wherein the curing accelerator is heat.

22. The method of claim 20 wherein the curing accelerator is a chemical curing agent.

23. A medical device comprising:
a substrate;
a recess on the substrate which defines a cavity having an opening, a securing portion, and one or more walls; and
a marking material, wherein the marking material is mechanically retained by the substrate, and wherein the marking material is adhesively bound to the substrate.

24. The medical device of claim 23 wherein the opening is an annular groove.

25. The medical device of claim 23 wherein the one or more walls are shaped such that an area defined by the opening is smaller than an area defined by the securing portion.

26. The medical device of claim 23 wherein the cavity is offset from the opening.

27. The medical device of claim 23 wherein the marking material is a pigmented epoxy system.
